(19) United States
(12) Patent Application Publication
(10) Pub. No.: US 2022/0329120 A1
(43) Pub. Date: Oct. 13, 2022

(54) ACTIVE PART OF AN ELECTRIC MACHINE, ELECTRIC MACHINE, AND METHOD FOR PRODUCING A PRE-MOUNTED ASSEMBLY FOR THE ACTIVE PART

(71) Applicant: Schaeffler Technologies AG & Co. KG, Herzogenaurach (DE)

(72) Inventors: Lars GEHRKE, Karlsuhe (DE); Sven-Erik ASMUSSEN, Karlsruhe (DE)

(73) Assignee: Schaeffler Technologies AG & Co. KG, Herzogenaurach (DE)

(21) Appl. No.: 17/638,274

(22) PCT Filed: Jul. 27, 2020
(86) PCT No.: PCT/DE2020/100665

§ 371 Date: Feb. 25, 2022

(30) Foreign Application Priority Data
Aug. 27, 2019 (DE) 102019122969.3

(51) Int. Cl. H02K 1/28; H02K 1/278; H02K 21/14; H02K 15/03

(52) U.S. Cl. CPC H02K 1/28; H02K 1/278; H02K 21/14; H02K 15/03

(57) ABSTRACT

An active part of an electric machine, the part being designed as a rotor or a stator for the electric machine, including a main part and a plurality of permanent magnets secured on/in the main part. The active part has one or more securing devices made of sheet metal, each of which holds at least one of the permanent magnets and via which the permanent magnets are secured on/in the main part. A corresponding electric machine and a method for producing a pre-mounted assembly for securing at least one permanent magnet to the main part of an active part of an electric machine, and the use of such pre-mounted assemblies are also provided.

### CROSS-REFERENCE TO RELATED APPLICATIONS

This application is the U.S. National Phase of PCT Appln. No. PCT/DE2020/100665, filed Jul. 27, 2020, which claims priority from German Patent Application No. 10 2019 122 969.3, filed Aug. 27, 2019, the entire disclosures of which are incorporated by reference herein.

### TECHNICAL FIELD

The disclosure relates to an active part of an electric machine designed as a rotor or a stator, having a main part and a plurality of permanent magnets secured on/in the main part.

The disclosure additionally relates to a corresponding electric machine, to a method for producing a pre-mounted assembly for securing at least one permanent magnet to the main part of an active part of an electric machine, and to the use of such pre-mounted assemblies.

### BACKGROUND

Such active parts (i.e., rotors or stators) of electric machines that have a plurality of permanent magnets secured on/in the main part are known. There are various examples in the literature of the type of securing of the permanent magnets on a corresponding main part of the active part. The document EP 2 149 965 A1 shows a rotor of a permanently excited synchronous machine, in which the permanent magnets are secured via a steel band wound around the main part and permanent magnets. The document DE 10 2017 203 736 A1 shows an electric machine designed as an electric motor with an internal rotor, which has a main part designed as a laminated core, permanent magnets arranged on the outer circumference of the main part and a rotor receiving sleeve circumferentially surrounding the laminated core and the permanent magnets. The permanent magnets are fixed in/on the laminated core via the rotor receiving sleeve and retaining devices formed by the laminated core between the permanent magnets. The document DE 20 2018 102 332 U1 shows a rotor of an external rotor motor having a main part that is designed as a laminated return ring and having permanent magnets secured thereto. The return ring has radial recesses and, connected thereto, flexible legs for securing the permanent magnets. There are also active parts of electric machines in which the permanent magnets are secured with adhesive.

The mounting of the permanent magnets on/in the main part is associated with a certain amount of effort in such active parts of electric machines.

### SUMMARY

It is the object of the disclosure to specify measures through which this effort is reduced.

The object is achieved according to the disclosure by the use of one or more of the features disclosed herein. Preferred designs are specified in below and in the claims, each of which either individually or in combination can represent an aspect of the disclosure.

In the active part according to the disclosure, which is designed as a rotor or stator for an electric machine and has a main part and a plurality of permanent magnets secured on/in the main part, it is provided that this active part of the electric machine has one or more securing devices made of sheet metal, each of which holds at least one of the permanent magnets and through which the permanent magnets are secured on/in the main part. Multiple securing devices are preferably provided. The electric machine is in particular a permanently excited synchronous machine. There are various applications for such electric machines, including automotive applications.

The term “hold” is to be understood as a gripping hold, similar to the setting of precious stones on pieces of jewelry. The production of the corresponding “holder” for the permanent magnets is usually different to a classic gemstone setting, in which the metal is driven over the stone to be set or held.

Using the mentioned securing devices made of sheet metal (for short: sheet metal securing devices), pre-mounted assemblies of permanent magnets and securing devices which hold or enclose these permanent magnets can be formed, which can be secured to the main part of the active part by means of the sheet metal securing devices. In this way, the active part of the electric machine can be constructed relatively easily and conveniently.

Accordingly, according to a preferred embodiment, the respective arrangement of at least one permanent magnet and a securing device that holds at least one permanent magnet forms a pre-mounted assembly that is secured on/in the main part. Such an assembly is significantly easier to handle when mounting the active part of the electric machine than the individual permanent magnet alone.

According to a further preferred embodiment, each of the permanent magnets is individually secured on/in the main part via one of the securing devices made of sheet metal. The pre-mounted assembly thus comprises exactly one permanent magnet per securing device (which holds this permanent magnet).

According to yet another preferred embodiment, the respective securing device has a securing part by means of which the arrangement is secured on/in the main part. The securing part in turn has one or a more securing structures.

In principle, securing can take place in a force-fitting and/or form-fitting and/or materially bonded manner. However, it is preferably provided that recesses are formed in the main part, into which at least part of the respective arrangement engages and there forms a permanent/non-detachable joint connection with the main part there. This at least one part of the respective arrangement is in particular the securing part of the corresponding securing device.

In the electric machine according to the disclosure with an active part embodied as a rotor and an active part embodied as a stator, it is provided that one of these active parts is embodied as the aforementioned active part.

In the method according to the disclosure for producing a pre-mounted assembly for securing at least one permanent magnet on the main part of an active part of an electric machine, in particular an active part, in particular an active part mentioned above, wherein the pre-mounted assembly is formed from an arrangement of the permanent magnet and a securing device holding this permanent magnet, and wherein the method comprises the following steps:

(i) providing the at least one permanent magnet and a sheet metal workpiece for producing the securing device from sheet metal;

(ii) preforming the sheet metal workpiece;

(iii) holding the at least one permanent magnet in the preformed sheet metal workpiece, and

(iv) forming the securing device from the preformed sheet metal workpiece. The term “hold” is to be understood as a gripping hold, similar to the setting of precious stones on pieces of jewelry. The “preforming” and the “forming” essentially take place by reshaping the sheet metal workpiece.

In this case, it is advantageously provided that during the forming process, a securing part of the securing device is formed, by means of which the arrangement can be secured on/in the main part.

With the use according to the disclosure of pre-mounted assemblies, which are formed by arrangements of one securing device and at least one permanent magnet held by this securing device, for the construction of an active part designed as a rotor or stator of an electric machine, the pre-mounted assemblies are secured on/in a main part of the active part.

It is preferably provided that recesses are formed in the main part, into which at least part of the respective arrangement, in particular a securing part of the securing device, engages and forms a press connection with the main part there.

### BRIEF DESCRIPTION OF THE DRAWINGS

In the following, the disclosure is explained by way of example with reference to the accompanying drawings using preferred exemplary embodiments, wherein the features shown below can represent an aspect of the disclosure both individually and in combination. In the figures:

FIG. 1: shows the two active parts of an electric machine, wherein one active part has permanent magnets and is designed according to a first preferred embodiment,

FIG. 2: shows the method steps for producing an individual securing device for holding one of the permanent magnets on the main part of the one active part shown in FIG. 1 and the enclosing of this permanent magnet in a retaining part of this securing device,

FIG. 3: shows the two active parts of an electric machine, wherein one active part has permanent magnets and is designed according to a second preferred embodiment, and

FIG. 4: shows the method steps for producing an individual securing device for holding one of the permanent magnets on the main part of the one active part shown in FIG. 3 and the enclosing of this permanent magnet in a retaining part of this securing device.

### DETAILED DESCRIPTION

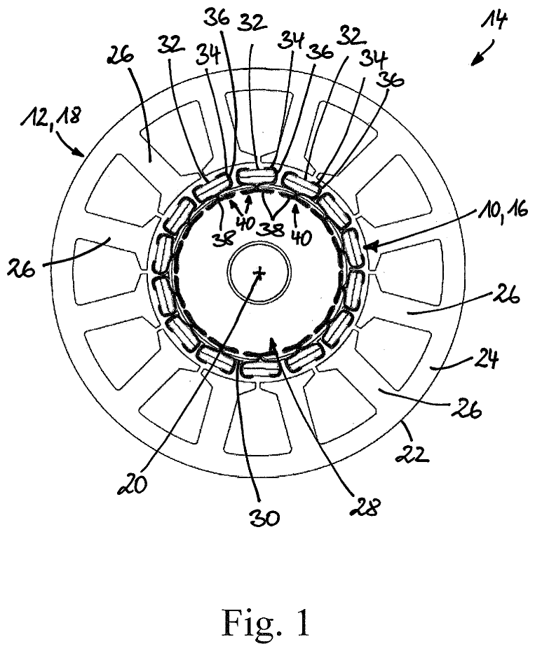

FIG. 1 shows the two active parts 10, 12 of an electric machine 14. Such an electric machine 14 can be designed as an electric motor, as a generator or as a motor generator. The first active part 10 of the electric machine 14 is designed as a rotor 16 and the second active part 12 of the electric machine 14 is designed as a stator 18. In contrast to the stator 18, the rotor 16 is rotatably supported with respect to an axis 20 in a housing (not shown) of the electric machine 14. The rotor 16 and the stator 18 are arranged coaxially with respect to the axis 20. There is an air gap therebetween. The electric machine 14 shown here is designed as an internal rotor machine, i.e., its rotor 16 is arranged radially inside the stator 18 with respect to the axis 20. The electric machine 14 shown here is a permanently excited synchronous machine.

Only a main part 22 of the stator 18 is shown, which has an annular or sleeve-shaped yoke 24 and teeth 26 facing radially inward for windings (not shown) of the stator 18. The main part 22 is formed, for example, by a laminated core.

The rotor 16 also has a main part 28, on the outer circumference 30 of which permanent magnets 32 are secured. The securing takes place by means of a plurality of securing devices 34 made of sheet metal, each enclosing one of the permanent magnets 32, i.e., sheet metal securing devices by means of which the permanent magnets 32 are secured on the main part 28. This main part 28 is also formed, for example, from a laminated core.

A respective arrangement 32, 34 results from one of the permanent magnets 32 and a securing device 34 holding this permanent magnet 32, wherein this arrangement forms a pre-mounted (sub)assembly which is secured on the main part 28.

Each of the securing devices 34 has a retaining part 36 that holds and thus retains the corresponding permanent magnet 32, as well as a securing part 38 having at least one securing structure by means of which the arrangement 32, 34 is secured on/in the main part 28. In this way, the outer circumference 30 of the main part 28 (of the active part 10 of the electric machine 14) is provided with permanent magnets 32 over the entire circumference with respect to the axis 20. These have an alternating magnetic polarity as seen in the circumferential direction.

The permanent magnets 32 can consist of different materials regardless of the machine type, namely: steel, aluminum-nickel-cobalt (AlNiCo magnets), bismanol, ferrites, rare earth materials (rare earth magnets) such as neodymium-iron-boron, samarium-cobalt, etc.

In electric machines 14 for automotive applications, space-optimized designs are predominantly to be found, whether in the small drives segment or in the traction drives segment. Due to the requirement to design in a space-optimized manner, electric machines 14 with a high power density are used, depending on the area of application. As shown in the example here, permanently excited synchronous machines with rare earth materials are often used.

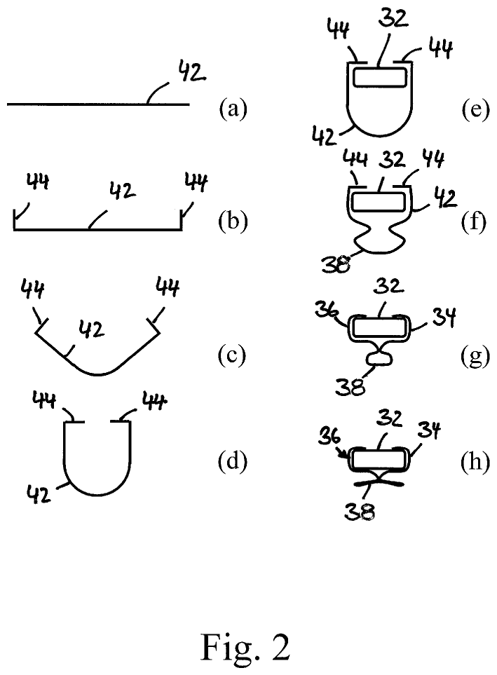

FIG. 2 shows the individual steps or sub-steps (a) to (h) for producing an individual securing device 34 for holding one of the permanent magnets 32 on the main part 28 of the first active part 10 shown in FIG. 1 and the enclosing of this permanent magnet 32 in the retaining part 36 of this securing device 34.

In step (a), the initial situation, there is a corresponding flat sheet metal workpiece 42 punched in shape.

In step (b), retaining tabs 44 are created at the ends of the sheet metal workpiece 42. The sheet metal workpiece 42 is then bent into a U-shape in steps (c) and (d) and is thereby preformed.

In step (e), the corresponding permanent magnet 32 is introduced into the preformed sheet metal workpiece 42. The retaining tabs 44 already overlap the permanent magnet 32. Then, in step (f) the U-shape of the preformed sheet metal workpiece 42 is provided with a type of constriction below the permanent magnet 32, which divides the preformed sheet metal workpiece 42 into two parts. The upper part with the permanent magnet 32 held therein is formed into the retaining part 36 by means of the further steps (g) and (h), and the lower part is formed into the securing part 38.

In step (g) the constriction is further reduced, so that the retaining part 36 is formed, and in step (h) a T-shaped central securing structure of the securing part 38 is formed. The securing device 34 is thus completely formed from the preformed sheet metal workpiece 42. The resulting arrangement of the permanent magnet 32 and the securing device 34 forms said pre-mounted assembly for the construction of the active part 10, designed as a rotor 16, of the electric machine 14 shown in FIG. 1.

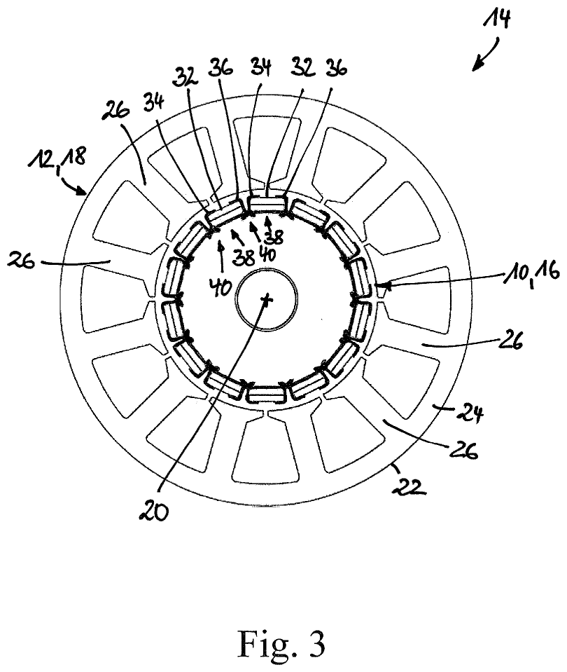

FIG. 3 shows the two active parts 10, 12 of a further variant of the electric machine 14. This differs only in details of the first active part 10 from the electric machine shown in FIG. 1. Therefore, in the following only the differences will be discussed.

The securing devices 34 have a modified shape in the area of their securing parts 38, which enables the pre-mounted assemblies to be alternatively pre-mounted in a chain-like manner and then “slipped” onto the active part 10, which simplifies the manufacturing process.

The pre-mounted assemblies produced in this way are now used to assemble the active part 10, which is designed as a rotor 16, of the electric machine 14. For this purpose, the pre-mounted assemblies are secured to the outer circumference 30 of the main part 28 of the active part 10 as follows:

Recesses 40 are formed in the main part 28, into which at least the securing part 38 of the securing device 34 is brought and pressed there so that it forms a press connection with the main part 28 there. In this way, all permanent magnets 32 are secured on the main part 28 of the first active part 10 of the electric machine.

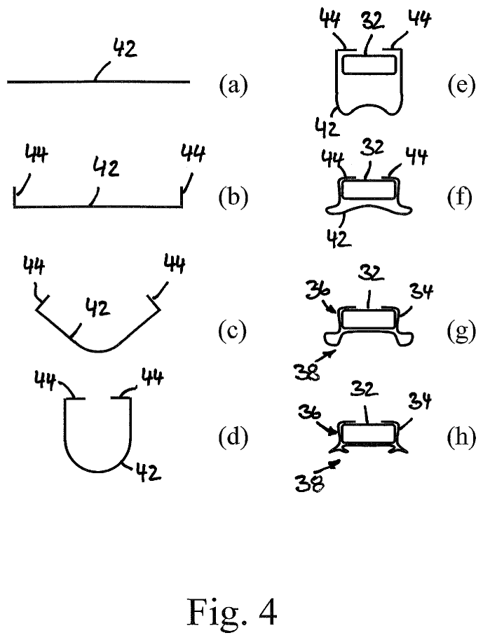

FIG. 4 shows the individual steps (a) to (h) for producing an individual securing device 34 for holding one of the permanent magnets 32 on the main part 28 of the first active part 10 shown in FIG. 3 and the enclosing of this permanent magnet 32 in the retaining part 36 of this securing device 34.

Steps (a) to (d) for preforming the sheet metal workpiece 42 are identical to steps (a) to (d) shown in FIG. 2.

In step (e), the corresponding permanent magnet 32 is introduced into the preformed sheet metal workpiece 42 and the base of the U-shape is additionally indented inward. The retaining tabs 44 already overlap the permanent magnet 32. Then, in step (f), the dent in the base of the U-shape of the preformed sheet metal workpiece 42 is enlarged until it reaches the permanent magnet. An upper and a lower part are created again. The upper part with the permanent magnet 32 held therein is formed into the retaining part 36 by means of the further steps (g) and (h), and the lower part is formed into the securing part 38.

In step (g) the dent is enlarged until it clings to the permanent magnet and the retaining part 36 is formed. This creates a tongue in each of the side areas of the securing part 38. These tongues are now formed into two securing structures of the securing part 38 in step (h). The securing device 34 is thus completely formed from the preformed sheet metal workpiece 42. The resulting arrangement of the permanent magnet 32 and the securing device 34 forms said pre-mounted assembly for the construction of the active part 10, designed as a rotor 16, of the electric machine 14 shown in FIG. 3.

In the following, details and advantages of selected embodiments according to the disclosure are to be described again in other words.

To produce the pre-mounted assemblies, the sheet metal workpieces 42, which mechanically hold the permanent magnets 32, grip around and thus fix them, are first punched out and cold-formed. The (sub)assemblies (the magnet 32 and the sheet metal workpiece 42) can then be pressed into the rotor assembly of the rotor 16.

Such a procedure has several advantages over the prior art:

1. Mechanical press connections can be calculated and simulated with great reliability; in the case of adhesive joints, however, each joint must be developed separately and tested in practice, since the only valid information in the data sheet of an adhesive is the temperature at which the adhesive is thermally destroyed.

2. The method is suitable for a large number of possible magnet shapes of the permanent magnets 32;

3. the mounting process can take place on separate mounting points;

4. no glue handling; no drying time;

5. the overlap area can be adjusted according to requirements, which allows the magnetic air gaps to be made smaller;

6. subsequent injection molding with plastic is also possible;

7. the “retaining plate” has a better magnetic flux-conducting material constant than an adhesive;

8. the thermal conductivity in the rotor 14 is improved;

9. the permanent magnets 32 are mechanically protected when they are pressed into the rotor 16, so that the protective surfaces are not damaged. As a result, simpler and cheaper surface treatments of the permanent magnets 32 are also possible.

### LIST OF REFERENCE SYMBOLS

10 First active part

12 Second active part

14 Electric machine

16 Rotor

18 Stator

20 Axis

22 Main part (stator)

24 Yoke (stator)

26 Tooth

28 Main part (rotor)

30 Outer circumference

32 Permanent magnet

34 Securing device

36 Retaining part (securing device)

38 Securing part (securing device)

40 Recess

42 Sheet metal workpiece

44 Retaining tab

1. An active part of an electric machine, said active part comprising:
a rotor or a stator for the electric machine, having a main part and a plurality of permanent magnets secured at least one of on or in the main part; and
one or more securing devices made of sheet metal, each of said securing devices holds at least one of the permanent magnets and secures the permanent magnets at least one of on or in the main part.

2. The active part according to claim 1, wherein an arrangement of one of these securing devices and at least one of the permanent magnets held by said securing device form a pre-mounted assembly which is secured at least one of on or in the main part.

3. The active part according to claim 1, wherein each of the permanent magnets is individually secured at least one of on or in the main part via one of the securing devices made of sheet metal.

4. The active part according to claim 2, wherein each respective securing device has a securing part by which the arrangement is secured at least one of on or in the main part.

5. The active part according to claim 2, further comprising recesses formed in the main part into which at least part of the respective arrangement engages and forms a permanent joint connection with the main part.

6. An electric machine, comprising an active part configured as a rotor and a second active part configured as a stator, wherein one of the first or second active parts comprises the active part according to claim 1.

7. A method for producing a pre-mounted assembly for securing at least one permanent magnet on a main part of an active part of an electric machine, the pre-mounted assembly being formed from an arrangement of the permanent magnet and a securing device holding the permanent magnet, the method comprising:
providing the permanent magnet and a sheet metal workpiece for producing the securing device from sheet metal;
preforming the sheet metal workpiece to form a preformed sheet metal workpiece;
holding the permanent magnet in the preformed sheet metal workpiece, and
forming the securing device from the preformed sheet metal workpiece.

8. The method according to claim 7, further comprising during the forming process, forming a securing part of the securing device by which the arrangement is securable at least one of on or in the main part.

9. A method of forming an electric machine, comprising:
providing a plurality of the pre-mounted assemblies formed according to the method of claim 8; and
securing the pre-mounted assemblies to an active part configured as a rotor or stator of an electric machine, with the pre-mounted assemblies being secured at least one of on or in a main part of the active part.

10. The method according to claim 9, further comprising forming recesses in the main part into which at least part of the respective arrangement engages and forms a press connection with the main part.

11. An active part of an electric machine, said active part comprising:
a rotor or a stator for the electric machine, having a main part;
one or more securing devices made of sheet metal, the securing devices each including at least one retaining tab configured for securing a permanent magnet, and at least one securing part on an opposite side of the securing device from the at least one retaining tab; and
a plurality of permanent magnets located in the securing devices and secured at least one of on or in the main part via the securing devices.

12. The active part according to claim 11, wherein each of the securing devices is formed from a single sheet metal strip.

13. The active part according to claim 11, wherein there are two of the securing parts on each of the securing devices.

14. The active part according to claim 11, wherein each said securing device is pre-assembled with at least one of the permanent magnets to form a pre-assembled arrangement.

15. The active part according to claim 14, wherein the main part includes a plurality of recesses, and a respective one of the arrangements is secured in each of the recesses to form a permanent connection with the main part.

16. The active part according to claim 11, wherein each of the permanent magnets is individually secured at least one of on or in the main part via one of the securing devices.

17. An electric machine, comprising an active part configured as a rotor and a second active part configured as a stator, wherein one of the first or second active parts comprises the active part according to claim 11.
